(19) United States
(12) Patent Application Publication
(10) Pub. No.: US 2025/0379794 A1
(43) Pub. Date: Dec. 11, 2025

(54) MODEL TRANSMISSION AND RECEPTION METHODS AND APPARATUSES

(71) Applicant: FUJITSU LIMITED, Kawasaki-shi (JP)

(72) Inventors: Yujia SHAN, Beijing (CN); Xin WANG, Beijing (CN); Meiyi JIA, Beijing (CN)

(73) Assignee: FUJITSU LIMITED, Kawasaki-shi (JP)

(21) Appl. No.: 19/301,192

(22) Filed: Aug. 15, 2025

Related U.S. Application Data
(63) Continuation of application No. PCT/CN2023/076604, filed on Feb. 16, 2023.

(51) Int. Cl. H04L 41/14; H04W 72/232

(52) U.S. Cl. CPC H04L 41/145; H04W 72/232

(57) ABSTRACT

A model transmission apparatus, configured in a terminal equipment, includes: a receiver configured to receive configuration information from a network device, the configuration information being used for configuring or indicating the terminal equipment to transmit at least a part of a model stored in the terminal equipment; and a transmitter configured to transmit the at least a part of the model to the network device according to the configuration information.

### CROSS-REFERENCE TO RELATED APPLICATION

This application is a continuation application under 35 U.S.C. 111 (a) of International Patent Application PCT/CN2023/076604 filed on Feb. 16, 2023, and designated the U.S., the entire contents of which are incorporated herein by reference.

### TECHNICAL FIELD

The present application relates to communication technical field.

### BACKGROUND

In recent years, artificial intelligence technology (AI/ML) represented by deep learning has developed rapidly and has been applied in multiple research and commercial fields due to its powerful nonlinear problem fitting ability. Similarly, the performance of artificial intelligence in various wireless communication applications has also been significantly improved compared with traditional methods. In the 3GPP standard discussion of RELASE 18, three applications, i.e., Channel State Information (CSI) feedback, beam management, and wireless positioning, of artificial intelligence in wireless communication have been preliminarily determined. In future discussions, introduction of more wireless communication applications that use artificial intelligence technology is not excluded.

Although the application of artificial intelligence in wireless communication may bring many benefits, such as reducing beam management resource overhead and improving wireless positioning accuracy, it also introduces some unique problems of artificial intelligence technology. One of the issues is the transmission of artificial intelligence models between wireless communication entities.

Generally speaking, the current main artificial intelligence technology is deep learning, and in deep learning, a model file (referred to as a model) is obtained after data training, and the model file stores neural network structure of a deep learning model and the weight parameters between the nodes in the network.

The application of this neural network model in wireless communication will generally face the following problems:

For example, since the neural network is “deep”, in order to achieve better nonlinear fitting ability, the number of layers and the number of neurons (nodes) required for each layer of the model are both not too small. The direct consequence resulting from this is that the storage space requirement of the model is relatively large, typically between 10-100 MB.

For example, due to the particularity of the wireless communication network, in some necessary cases, the model needs to be transmitted between various entities such as user equipment (UE), a base station (gNB), a location management function (LMF) entity, an access and mobility management function (AMF) entity, and etc., and transmission must ensure certain quality requirements, such as integrity, timeliness, etc. If these requirements cannot be met, it will lead to a significant decline in the performance of the artificial intelligence model in a certain application, and may even fail to meet the minimum requirements of a certain application, forcing the abandonment of the use of artificial intelligence algorithms.

It should be noted that, the above introduction to the background is merely for the convenience of clear and complete description of the technical solution of the present application, and for the convenience of understanding of persons skilled in the art. It cannot be regarded that the above technical solution is commonly known to persons skilled in the art just because that the solution has been set forth in the background of the present application.

### SUMMARY

However, the inventor finds that the wireless interface transmission supported in the current 3GPP protocol is difficult to meet the requirements of AI/ML model transmission in terms of size of transmitted data, transmission quality, and delay control, and is not able to solve various potential problems caused by the transmission of AI/ML models between entities.

To address at least one of the above problems, provided in the embodiments of the present application are model transmission and reception methods and apparatuses, in which interaction is performed between network entities and/or between a network entity and a terminal, at least part of the model is transmitted as needed based on interaction information, thus it is possible to achieve air interface transmission of relatively large models, meet the requirements of AI/ML model transmission, and solve various potential problems caused by the transmission of AI/ML models between entities.

According to an aspect of the embodiments of the present application, there is provided with a model transmission method, including:
a terminal equipment receiving configuration information from a network device, the configuration information being used for configuring or indicating the terminal equipment to transmit at least a part of a model stored in the terminal equipment;
the terminal equipment transmitting the at least a part of the model to the network device according to the configuration information.

According to another aspect of the embodiments of the present application, there is provided with a model transmission apparatus, including:
a first receiving unit configured to receive configuration information from a network device, the configuration information being used for configuring or indicating the terminal equipment to transmit at least a part of a model stored in the terminal equipment; and
a first transmitting unit configured to transmit the at least a part of the model to the network device according to the configuration information.

According to another aspect of the embodiments of the present application, there is provided with a model reception method, including:
a network device transmitting configuration information to a terminal equipment, the configuration information being used for configuring or indicating the terminal equipment to transmit at least a part of a model stored in the terminal equipment; and
the network device receiving the at least a part of the model transmitted by the terminal equipment according to the configuration information.

According to another aspect of the embodiments of the present application, there is provided with a model reception apparatus, including:
a second transmitting unit configured to transmit configuration information from a network device to a terminal equipment, the configuration information being used for configuring or indicating the terminal equipment to transmit at least a part of a model stored in the terminal equipment; and
a second receiving unit configured to receive the at least a part of the model transmitted by the terminal equipment according to the configuration information.

According to another aspect of the embodiments of the present application, there is provided with a communication system, including:
a network device configured to transmit configuration information to a terminal equipment, the configuration information being used for configuring or indicating the terminal equipment to transmit at least a part of a model stored in the terminal equipment; and receive the at least a part of the model transmitted by the terminal equipment according to the configuration information; and
the terminal equipment configured to receive the configuration information, and transmit the at least a part of the model according to the configuration information.

One of the beneficial effects of the embodiment of the present application is in: interaction is performed between a network device and a terminal equipment, part of the model is transmitted as needed based on interaction information, thus it is possible to achieve air interface transmission of relatively large models, meet the requirements of AI/ML model transmission, and solve various potential problems caused by the transmission of AI/ML models between entities.

With reference to the specification and drawings below, specific embodiments of the present application are disclosed in detail, which specify the manner in which the principle of the present application may be adopted. It should be understood that, the scope of the embodiments of the present application is not limited. Within the scope of the spirit and clause of the appended claims, the embodiments of the present application include many variations, modifications and equivalents.

The features described and/or shown for one embodiment may be used in one or more other embodiments in the same or similar manner, may be combined with the features in other embodiments or replace the features in other embodiments.

It should be emphasized that, the term “include/comprise” refers to, when being used in the text, existence of features, parts, steps or assemblies, without exclusion of existence or attachment of one or more other features, parts, steps or assemblies.

### BRIEF DESCRIPTION OF THE DRAWINGS

Elements and features described in one of the drawings or embodiments of the present application may be combined with the elements and features shown in one or more other drawings or embodiments. Moreover, in the drawings, similar reference signs indicate corresponding parts in several drawings and may be used to indicate corresponding parts used in more than one embodiment.

The included drawings are used for providing further understanding on the embodiments of the present application, constitute a portion of the description, are used for illustrating the embodiments of the present application and explain the principle of the present application together with the literary description. Obviously, the drawings described below are merely some examples of the present application, persons ordinarily skilled in the art may also obtain other drawings according to these drawings without making creative efforts. In the drawings:

FIG. 1 is a schematic diagram of the application scenario of the embodiments of the present application;

FIG. 2 is a schematic diagram of a model transmission method in the embodiments of the present application;

FIG. 3 is an example diagram of a model transmission method in the embodiments of the present application;

FIG. 4 is another example diagram of a model transmission method in the embodiments of the present application;

FIG. 5 is another example diagram of a model transmission method in the embodiments of the present application;

FIG. 6 is another schematic diagram of a model reception method in the embodiments of the present application;

FIG. 7 is a schematic diagram of a model transmission apparatus in the embodiments of the present application;

FIG. 8 is a schematic diagram of a model reception apparatus in the embodiments of the present application; and

FIG. 9 is a schematic diagram of an electronic device in the embodiments of the present application.

### DETAILED DESCRIPTION

With reference to the drawings, the foregoing and other features of the present application will become apparent through the following specification. The description and drawings specifically disclose the particular embodiments of the present application, showing part of the embodiments in which the principle of the present application may be adopted, it should be understood that the present application is not limited to the described embodiment, on the contrary, the present application includes all modifications, variations and equivalents that fall within the scope of the appended claims.

In embodiments of the present application, the terms “first”, “second”, etc., are used to distinguish different elements by their appellation, but do not indicate the spatial arrangement or chronological order of these elements, etc., and these elements shall not be limited by the terms. The term “and/or” includes any and all combinations of one or more of the terms listed in association with the term. The terms “contain”, “include”, “have”, etc., refer to the presence of the stated feature, element, component or assembly, but do not exclude the presence or addition of one or more other features, elements, components or assemblies.

In the embodiments of the present application, the singular forms “one”, “the”, etc., including the plural forms, shall be broadly understood as “a sort of” or “a kind of” and not limited to the meaning of “one”; furthermore, the term “said” shall be understood to include both the singular form and the plural form, unless it is expressly indicated otherwise in the context. In addition, the term “according to” should be understood to mean “at least partially according to . . . ”, and the term “based on” should be understood to mean “based at least partially on . . . ”, unless it is expressly indicated otherwise in the context.

In embodiments of the present application, the term “communications network” or “wireless communications network” may refer to a network that complies with any of the following communication standards, such as Long Term Evolution (LTE), Long Term Evolution-Advanced (LTE-A), Wideband Code Division Multiple Access (WCDMA), High-Speed Packet Access (HSPA), etc.

In addition, the communication between the devices in the communication system may be carried out according to the communication protocol of any stage, for example, including but not being limited to 1G (generation), 2G, 2.5G, 2.75G, 3G, 4G, 4.5G and future 5G, New Radio (NR), etc., and/or other communication protocols currently known or to be developed in the future.

In the embodiments of the present application, the term “network device” refers to, for example, a device in the communication system that connects a terminal equipment to the communication network and provides services to the terminal equipment. The network device may include but is not limited to: a base station (BS), an access point (AP), a transmission reception point (TRP), a broadcast transmitter, a mobile management entity (MME), a gateway, a server, a radio network controller (RNC), a base station controller (BSC), etc.

The base station may include, but is not limited to, a node B (NodeB or NB), an evolution node B (eNodeB or eNB), 5G base station (gNB), an IAB donor, etc., and may also include a remote radio head (RRH), a remote radio unit (RRU), a relay, or a low-power node (such as femto, pico, etc.). And the term “base station” may include some or all of their functions, with each base station providing communication coverage to a specific geographic area. The term “cell” may refer to a base station and/or its coverage area, depending on the context in which the term is used.

In the embodiments of the present application, the term “user equipment” (UE) refers, for example, to a device that is connected to the communication network through the network device and receives network services, and may also be referred to as “Terminal Equipment” (TE). The terminal equipment may be fixed or movable, and may also be called a mobile station (MS), a terminal, a user, a subscriber station (SS), an access terminal (AT), a station, etc.

The terminal equipment may include but is not limited to: a cellular phone, a personal digital assistant (PDA), a wireless modem, a wireless communication device, a handheld device, a machine-type communication device, a laptop computer, a cordless phone, a smart phone, a smart watch, a digital camera, etc.

For another example, in scenarios such as Internet of Things (IoT), the terminal equipment may also be a machine or an apparatus that performs monitoring or measurement, and may include, but is not limited to, a machine type communication (MTC) terminal, a vehicle communication terminal, a device to device (D2D) terminal, a machine to machine (M2M) terminal, and etc.

Hereinafter the scenarios of in the embodiments of the present application are illustrated by examples, but which is not limited in the present application.

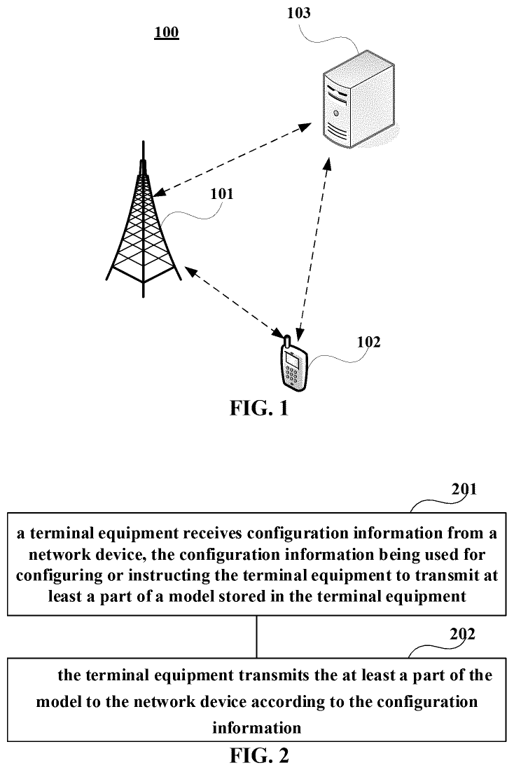

FIG. 1 is a schematic diagram of a communication system in the embodiments of the present application, illustrating the case of the terminal equipment and the network device as examples. As shown in FIG. 1, a communication system 100 may include a network device 101, a terminal equipment 102 and a location server 103. For simplicity, FIG. 1 illustrates only one terminal equipment and one network device as an example, but which is not limited in the embodiments of the present application.

In the embodiments of the present application, existing services or services that may be implemented in the future may be transmitted between the network device 101 and the terminal equipment 102. For example, these services may include, but are not limited to, enhanced Mobile Broadband (eMBB), massive Machine Type Communication (mMTC), and Ultra-Reliable and Low-Latency Communication (URLLC), and etc.

It is worth noting that FIG. 1 shows that the terminal equipment 102 is within the coverage of the network equipment 101, but which is not limited in the present application. The terminal equipment 102 may not be within the coverage of the network device 101. In addition, FIG. 1 illustrates the deployment of the location server 103 alone as an example, where an AI/ML model may be run in the location server 103 to obtain a location result; but the present application is not limited to this, and the location server 103 may be deployed in the core network, or in the network device 102 (such as a base station), or in the terminal equipment 103, which are not limited in the embodiments of the present application.

In the embodiments of the present application, a terminal equipment to be located may be referred to as a target device, and the function of the location server may be referred to as Location Management Function (LMF). LMF may refer to a network entity that locates and manages the terminal, or a location server with location and management functions may be abbreviated as LMF. The terms “LMF” and “location server” may be replaced with each other without causing confusion. For the specific content of these concepts and positioning, please refer to relevant technologies.

In the embodiments of the present application, the model transmission apparatus (also referred to as a model transmission module or a model transmission entity) is a terminal equipment, but it may also be an entity of gNB or a core network (such as LMF or AMF), or it may be a partial function or entity of any of the above devices. The model reception apparatus (also referred to as a model reception module or a model reception entity) is a network device, but it may also be an entity of UE or a core network (such as LMF or AMF), or it may be a partial function or entity of any of the above devices. In addition, FIG. 1 illustrates positioning as an example, but the present application is not limited to this. The model transmission scheme of the present application may be applied to any scenario using the AI/ML model.

The wireless interface transmission supported in the current 3GPP protocol includes: control plane transmission and user plane transmission. A signaling radio Bearer (SRB) and a data radio bearer (DRB) correspond to the above two types of transmission, respectively. Both of the mechanisms have inherent defects when implementing AI/ML model transmission:
if SRB is configured for control plane transmission, although SRB transmitted by a RRC message has a higher transmission priority, the amount of data that may be carried by one RRC message is relatively limited. When the model is large, it needs to be transmitted by many RRC messages if SRB is used alone, and may not be received in terms of efficiency and time delay;
if DRB is configured for user plane transmission, although it may carry a large amount of data, DRB has a low transmission priority, and the transmitted content is invisible, which also has problems in terms of quality and time delay control.

Therefore, the current mechanism is not able to solve various potential problems caused by the transmission of AI/ML models between entities.

### Embodiments of First Aspect

The embodiments of the present application provide a model transmission method, which is explained from the side of a model transmission apparatus. The model transmission apparatus is a terminal equipment (such as a target device, PRU, or other terminals) or a module or functional entity in the terminal equipment, but the present application is not limited to this. For example, it may also be a network device (such as a base station) or a location server with LMF functionality.

FIG. 2 is a schematic diagram of a signal transmission method in the embodiments of the present application. As shown in FIG. 2, the method includes:

201: a terminal equipment receives configuration information from a network device, the configuration information being used for configuring or indicating the terminal equipment to transmit at least a part of a model stored in the terminal equipment;

202: the terminal equipment transmits the at least a part of the model to the network device according to the configuration information.

It is worth noting that FIG. 2 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 2 above.

Accordingly, interaction is performed between a network device and a terminal equipment, part of the model is transmitted as needed based on interaction information, thus it is possible to achieve air interface transmission of relatively large models, meet the requirements of AI/ML model transmission, and solve various potential problems caused by the transmission of AI/ML models between entities.

In some embodiments, the configuration information includes at least model information and/or transmission information.

For example, the model information includes at least one of the following: model structure, model type, model layer information, model parameter information, model weight type, model weight accuracy, or model transmission type. The present application is not limited to this, and may also be any combination of the above information, or include other information.

For example, the configuration information may specify the type or content or the like of model transmission. Various contents may be predefined in advance, and then predefined content 1, predefined content 2, . . . , predefined content N, etc. may be included in the configuration information. The predefined content achieves consistency across the network device and the terminal equipment by the way of, for example, UE capability reporting or model identification as described later or the like.

In some embodiments, the transmission information may include transmission configuration information and/or transmission format information.

For example, the transmission configuration information includes at least one of the following: transmission period, maximum available resources for transmission, maximum time delay for transmission, or transmission silence window. The present application is not limited to this, and may also be any combination of the above information, or include other information.

For example, the transmission format information may indicate a universal storage format of the AI/ML model (e.g., including ONNX, PYTORCH, etc.); or may also indicate a data transmission format defined currently or in the future in the wireless communication network, and may also indicate a non-universal storage format that may be compilable. The receiver may inform the transmitter through the transmission format information that files or data that carry the model are transmitted in a predefined format.

For another example, the network device may indicate the terminal equipment through the configuration information to only transmit part of the content that has changed compared to the previous transmission, and the definition of “change” may be given by the network device in different forms through a RRC message. For example, the network device may be configured with an upper limit of transmission content, and the terminal equipment may decide by itself which contents need to be transmitted within the upper limit range. For another example, the network device may provide detailed definitions of the upper limit of the content, such as an upper limit of number of parameters, and an upper limit of total transmission overhead.

For another example, the network device may also specify a threshold for the “change” through the configuration information. For example, the network device may also provide other relevant information about relative value model parameters to the terminal equipment, such as using configuration parameters to specify a certain threshold for the relative change value, and specify that the terminal equipment transmits the parameter only when the relative change value of the parameter meets this condition. For another example, the network device may also specify the number of model parameters to be transmitted to the terminal equipment and transmits a response parameter selection mechanism. For instance, it may be agreed that only 500 parameters with the greatest relative change values need to be transmitted. In the above example, “relative change value” is, for instance, a difference between the parameter value of the current model to be transmitted and the parameter value of the previous model to be transmitted, which may be an absolute value (non negative) or a relative value of the difference.

In some embodiments, the terminal equipment transmits terminal capability information and/or model identification information to the network device, the terminal capability information and/or the model identification information being used by the network device to generate the configuration information.

For example, before the network device transmits the configuration information, the terminal equipment may interact with the network device using UE capability IE or model identification IE, so that the network device may transmit the configuration information to the terminal device in a targeted manner.

In some embodiments, the network device transmits a request for requesting terminal capability and/or model identification to the terminal equipment; the terminal equipment transmits the terminal capability information and/or the model identification information to the network device according to the request. The terminal capability information and/or the model identification information include information of capability for transmitting part of the content of the model.

For example, the network device may inquire with the terminal equipment whether it has the capability to transmit models, whether it has the capability to transmit only part of the content of the model (such as only transmitting model parameters, only transmitting model structures), whether it has the capability to acquire and transmit the relative change values of model parameters, and so on. The terminal equipment reports the above capabilities through the UE Capability method as needed according to the requirements of the network device.

For example, the terminal equipment may report a model identity number (or referred to as a model identity sequence, a model identifier, a model ID) and/or other related information corresponding to the above model to network device through the model identification process. The model identity number or other related information contains various capability information related to the transmission of part of the content of the model.

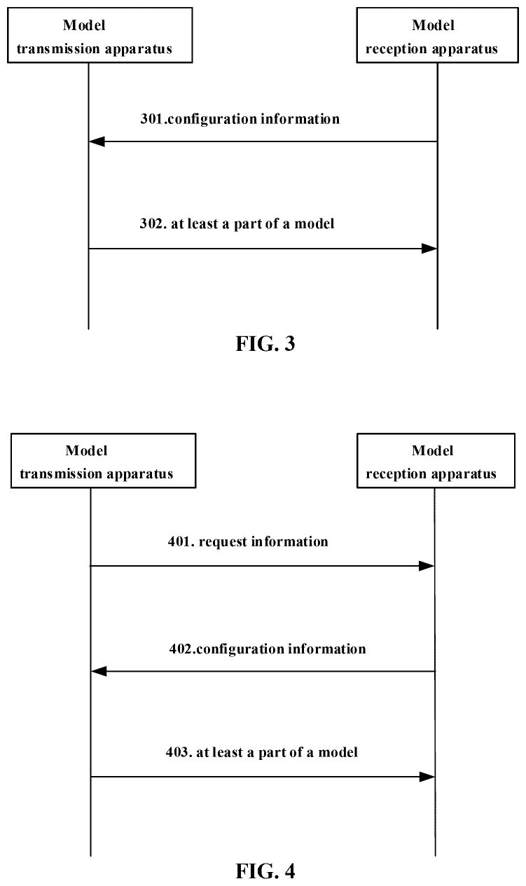

FIG. 3 is an example diagram of a model transmission method in the embodiments of the present application. For example, the model transmission apparatus is UE and the model reception apparatus is gNB. Before the transmission of the model, the transmission apparatus and the reception apparatus may perform signaling communication as regards the basic requirements of the model transmission.

As shown by 301 in FIG. 3, the configuration information may be actively transmitted by the model reception apparatus to the model transmission apparatus through a RRC message, MAC CE, DCI/UCI, and other methods. As shown by 302 in FIG. 3, the model transmission apparatus transmits at least part of the model based on these configuration information. Therefore, for example, only akey part of the current application model may be transmitted as needed, and in some cases, SRB may be used to achieve efficient transmission of the model.

It is worth noting that FIG. 3 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 3 above.

In some embodiments, at least part of the model is transmitted through a signaling radio bearer (SRB) and/or a data radio bearer (DRB). For example, at least part of the model shown in 302 is transmitted through SRB, or through DRB, or through both SRB and DRB.

In some embodiments, the configuration information is transmitted through at least one of the following: a radio resource control (RRC) message, a medium access control (MAC) control element (CE), or downlink control information (DCI). For example, the model transmission information in 301 is transmitted through DCI. In addition, depending on difference between the model transmission apparatus and the model reception apparatus, the configuration information may also be uplink control information (UCI), LPP (LTE Positioning Protocol) signaling, and NRPPa (NR Positioning Protocol A) signaling.

Hereinafter the configuration information is further explained.

For example, when gNB selects to transmit model structure information to UE, it may use IE to select the preset model structure information; for example, it may be in a character string form or a data bit form. For example, a ModeType of an enumeration type may be used, including information indicating the model structure such as “CNN”, “DNN”, “RNN”, “Transformer”, etc. For another example, ModelType of an enumeration type may be used, including {0, 1, 2, . . . 15}. For example, 0-15 represent 16 preset network structures respectively, such as CNN, Transformer, etc., or other types may be specified.

For another example, when gNB selects to transmit model structure information to UE, it may use IE to specify the neural network model structure information, which may specify a model structure that is not limited to the preset one. For example, IE may be as shown in Table 1:

TABLE 1

| | |
|---|---|
| ModelLayerList | SEQUENCE (SIZE(1...maxLayerNum) OF ModelLayerInfo |
| ModelLayerInfo | SEQUENCE{ |
| LayerID | Integer(0...maxLayerNum) |
| neuronNum | Integer(0...maxNeuronNum) |

...,
}

The model structure information has been exemplarily illustrated hereinbefore, and hereinafter model parameter information will be exemplarily illustrated.

For example, if gNB selects to transmit model parameter information to UE, it may use IE to select the model parameters. For example, expressions such as “absolute” and “relative” and the like are used to indicate whether the model parameters are relative change values or absolute values.

For another example, if gNB selects to transmit model parameter information to UE, it may use IE to specify the accuracy information of the model parameters. For example, ModelWeightsAccuracy of an enumeration type may be used, including {0, 1, 2, . . . 15}. For example, 0-15 correspond to the number of digits after the decimal point of a weight parameter respectively, to thereby indicate the accuracy of the model parameter.

The model parameter information has been exemplarily illustrated hereinbefore, and hereinafter transmission type information will be exemplarily illustrated.

For example, if gNB selects to transmit model transmission type information to UE, it may use IE to specify the model transmission type. For example, IE of an enumeration type may be used to define the above model transmission types, such as ModelTransmissionType, which includes information indicating the model transmission type such as “structure-only”, “weights-only”, “parameter-only”, “partial-parameter”, “hybrid”, “full”, etc., which may correspond respectively, for example, to only transmitting model structure, only transmitting model weights, only transmitting model parameters, transmitting part of model parameters, hybrid transmission, full transmission, etc.

The transmission type information has been exemplarily illustrated hereinbefore, and hereinafter transmission configuration information will be exemplarily illustrated.

For example, when gNB selects to transmit model transmission configuration information to UE, it may use IE to specify the model transmission configuration. For example, multiple parallel IEs may be used, or a single overall IE may be used, as shown in Table 2.

TABLE 2

| | |
|---|---|
| ModelTransmissionConfig | SEQUENCE{ |
| Period | ENUMERATED(ms0.1, ms0.5, ms1, ms2, ..., ms4000, |

...)

| | |
|---|---|
| MaxLatency | ENUMERATED (ms0.1, ms0.5, ms1, ms2, ..., ms4000, |

...)

| | |
|---|---|
| SilenceWindow | SilenceWindow |

...,

In Table 2, for example, Period specifies the transmission period, MaxLatency specifies the maximum time delay for model reception, both of which may be identified in time units such as ms. SilenceWindow specifies that model transmission is not received during a certain period of time, which may be defined using concepts such as SFN.

The configuration information has been exemplarily illustrated hereinbefore, and the present application is not limited to this.

In some embodiments, the terminal equipment receives assistance information from the network device; the assistance information includes an expected performance and/or expected maximum time of reception.

For example, the assistance information includes relevant information about the application that needs to use the model to be transmitted, such as an expected performance gain of the application, a maximum time limit expected to be received by the application, etc. The assistance information may be transmitted to the terminal equipment together with the configuration information, or transmitted separately using different RRC signaling, or the assistance information may also serve as part of the configuration information.

In some embodiments, the model transmission apparatus transmits request information for requesting the configuration information to the model reception apparatus.

FIG. 4 is another example diagram of a model transmission method in the embodiments of the present application. For example, the model transmission apparatus is UE and the model reception apparatus is gNB. Before the transmission of the model, the transmission apparatus and the reception apparatus may perform signaling communication as regards the basic requirements of the model transmission.

As shown by 401 in FIG. 4, UE may transmit request information to gNB to request gNB to feed back the configuration information. As shown by 402 in FIG. 4, the configuration information may be fed back to the model transmission apparatus by the model reception apparatus as needed. For example, the model reception apparatus feeds the configuration information back to the model transmission apparatus through a RRC message, MAC CE, DCI/UCI, and other methods. As shown by 403 in FIG. 4, the model transmission apparatus transmits at least part of the model based on these information. Therefore, for example, only a key part of the current application model may be transmitted as needed, and in some cases, SRB may be used to achieve efficient transmission of the model.

It is worth noting that FIG. 4 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 4 above.

In some embodiments, the request information includes at least one of the following: model content information, model transmission configuration information, or model type information. The present application is not limited to this, and may also be any combination of the above information, or include other information.

For example, the model content information includes at least one of the following: model structure information, neural network layer information, weight information, partial model content information, weight location information, partial model content location information, model storage related information, or content information carrying model data.

In some embodiments, the request information is transmitted through at least one of the following: a radio resource control (RRC) message, a medium access control (MAC) control element (CE), or uplink control information (UCI). The present application is not limited to this. For example, depending on the transmitter and the receiver, the request information may also be downlink control information (DCI), LPP signaling, or NRPPa signaling.

In some embodiments, the model transmission apparatus may also transmit specified information for generating or reassembling the model to the model reception apparatus.

For example, after the information collection is completed in the earlier stage, the model transmission apparatus needs to transmit model files or data to the model reception apparatus, and in addition transmits model data related information (specified information) as needed so that the model receiver may reassemble the received information into a complete model file. The specified information may be transmitted together with the model or separately.

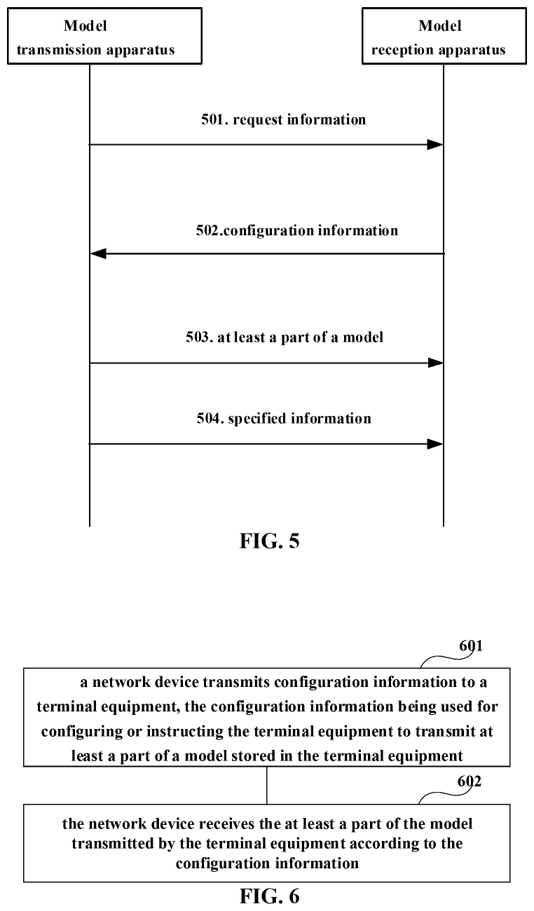

FIG. 5 is another example diagram of a model transmission method in the embodiments of the present application. For example, the model transmission apparatus is UE and the model reception apparatus is gNB. Before the transmission of the model, the transmission apparatus and the reception apparatus may perform signaling communication as regards the basic requirements of the model transmission.

As shown by 501 in FIG. 5, UE may transmit request information to gNB to request gNB to feed back the configuration information. As shown by 502 in FIG. 5, the configuration information may be fed back to the model transmission apparatus by the model reception apparatus as needed. For example, the model reception apparatus feeds the configuration information back to the model transmission apparatus through a RRC message, MAC CE, DCI/UCI, and other methods. As shown by 503 in FIG. 5, the model transmission apparatus transmits at least part of the model based on these information. Therefore, for example, only akey part of the current application model may be transmitted as needed, and in some cases, SRB may be used to achieve efficient transmission of the model.

As shown by 504 in FIG. 5, the model transmission apparatus may also transmit specified information to the model reception apparatus. The model reception apparatus may perform operations such as reassembly on at least part of files of the received model based on the specified information to obtain a complete model.

It is worth noting that FIG. 5 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 5 above.

For example, 501 in FIG. 5 may be omitted, and gNB actively transmits configuration information to UE. For example, 503 and 504 may be merged together, to transmit the specified information while transmitting at least a portion of the model. For example, the specified information is transmitted before at least a portion of the model. For another example, the specified information is transmitted as part of at least a portion of the model.

In some embodiments, the specified information including at least one of the following: model identity information, content description information, data statistics information, or model content information. The model content information may include, for example, weight initialization information, partial model content initialization information, and partial weight information.

For example, the relevant information of model weight initialization may be transmitted from the model transmission apparatus to the model reception apparatus. These information may be transmitted using IE, as shown in Table 3:

TABLE 3

| | |
|---|---|
| WeightsInitType | ENUMERATED{fixed, random, pre-trained, ...} |

WeightsRandomInitType ENUMERATED{xavier, he, uniform, ...}

In some embodiments, the partial weight information includes: layer identity, inter layer location identity, intra layer location identity, and weight difference corresponding to the location; the partial model content information includes: content identity, content location identity, and weight difference corresponding to the location.

For example, the model transmission apparatus transfers relevant information about partial model transmission location and a relative difference to the model reception apparatus, thus it is possible to avoid transmitting all model weights simultaneously, thereby reducing transmission resource consumption. These information may be transmitted using IE, as shown in Table 4:

TABLE 4

| | |
|---|---|
| WeightsPatialTransmissionInfo | SEQUENCE (SIZE(1...maxPartialWeightsNum) OF |

PartialWeightsInfo

| | |
|---|---|
| PartialWeightsInfo | SEQUENCE{ |
| LayerID | INTEGER(0,...,maxLayerNum) |
| PositionID | INTEGER(0,...,maxNeuronNum−1) |
| ValueDifference | valueDifference |

}

In Table 4, it shows the inter layer location and intra layer location of the weights that need to be updated, as well as the weight difference values that need to be transmitted.

The above Tables 1 to 4 only exemplarily illustrate some examples of interaction information in the embodiments of the present application, and the present application is not limited to them. For example, these contents may reuse existing IEs, use new IEs, or use other information transmission methods.

In some embodiments, the network device may also transmit indication information for retransmitting or suspending or terminating transmission.

For example, after reception of at least a part of the model transmitted by the terminal equipment, the network device may also configure or indicate the terminal equipment through a RRC message, allowing the terminal equipment to complementally transmit and retransmit the transmission content. In addition, the network device may also suspend or terminate model transmission in advance through a RRC message or DCI after receiving the partial transmission content. The above “partial transmission” refers, for example, to the behavior that the terminal equipment selects a portion of the corresponding content of the model and transmits it to the network device according to the requirements of the network device.

The above explanation is based on the example of a data transmission apparatus as the terminal equipment and a data reception apparatus as the network device. The present application is not limited to this, and the following explanation will be given by taking a data transmission apparatus as the network device and a data reception apparatus as the terminal equipment, and the same content mentioned above will be omitted.

In some embodiments, the network device transmits configuration information to the terminal equipment, and the configuration information is used for configuring or indicating the terminal equipment to receive at least a part of a model stored in the network device; the network device transmits the at least a part of the model to the terminal equipment according to the configuration information.

In some embodiments, the configuration information is carried by at least one of a radio resource control message, a medium access control control element, or downlink control information.

In some embodiments, at least part of the model is transmitted through a signaling radio bearer (SRB) and/or a data radio bearer (DRB).

In some embodiments, the at least a part of the model is carried by at least one of a radio resource control (RRC) message, a medium access control (MAC) control element (CE), or downlink control information (DCI).

In some embodiments, the network device receives terminal capability information and/or model identification information transmitted by the terminal equipment, the terminal capability information and/or the model identification information being used by the network device to generate the configuration information.

In some embodiments, the network device transmits a request for requesting terminal capability and/or model identification to the terminal equipment, wherein the terminal equipment transmits the terminal capability information and/or the model identification information to the network device according to the request.

In some embodiments, the terminal capability information and/or the model identification information include information of capability for transmitting part of the content of the model.

In some embodiments, the configuration information includes model information and/or transmission information.

In some embodiments, the network device receives request information for requesting the configuration information transmitted by the terminal equipment.

In some embodiments, the request information includes at least one of the following: model content information, model transmission configuration information, or model type information.

In some embodiments, the request information is transmitted through at least one of the following: a radio resource control (RRC) message, a medium access control (MAC) control element (CE), or uplink control information (UCI).

In some embodiments, the network device receives assistance information from the terminal equipment; the assistance information includes an expected performance and/or expected maximum time of reception.

In some embodiments, the network device transmits specified information for generating or reassembling the model to the terminal equipment.

In some embodiments, the specified information includes at least one of the following: model identity information, content description information, data statistics information, or model content information.

In some embodiments, the network device transmits indication information of retransmitting or suspending transmission or terminating transmission to the terminal equipment.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, interaction is performed between a network device and a terminal equipment, part of the model is transmitted as needed based on interaction information, thus it is possible to achieve air interface transmission of relatively large models, meet the requirements of AI/ML model transmission, and solve various potential problems caused by the transmission of AI/ML models between entities.

### Embodiments of Second Aspect

The embodiments of the present application provide a model reception method, which is explained from the side of a model reception apparatus. The embodiments of the second aspect correspond to that of the first aspect, and the same content will not be repeated.

FIG. 6 is another schematic diagram of a model reception method in the embodiments of the present application. As shown in FIG. 6, the method includes:

601: a network device transmits configuration information to a terminal equipment, the configuration information being used for configuring or indicating the terminal equipment to transmit at least a part of a model stored in the terminal equipment; and

602: the network device receives the at least a part of the model transmitted by the terminal equipment according to the configuration information.

It is worth noting that FIG. 6 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 6 above.

In some embodiments, the configuration information includes model information and/or transmission information.

For example, the model information includes at least one of the following: model structure information, model type information, model layer information, model parameter information, model weight type, model weight accuracy information, or model transmission type.

For another example, the transmission information may include transmission configuration information and/or transmission format information; the transmission configuration information includes at least one of the following: transmission period, maximum available resources for transmission, maximum time delay for transmission, or transmission silence window.

In some embodiments, the network device receives terminal capability information and/or model identification information from the terminal equipment, the terminal capability information and/or the model identification information being used by the network device to generate the configuration information.

In some embodiments, the network device transmits a request for requesting terminal capability and/or model identification to the terminal equipment; the terminal equipment transmits the terminal capability information and/or the model identification information to the network device according to the request.

In some embodiments, the terminal capability information and/or the model identification information include information of capability for transmitting part of the content of the model.

In some embodiments, the configuration information is carried by at least one of a radio resource control message, a medium access control control element, or downlink control information.

In some embodiments, the at least a part of the model is transmitted via a signaling radio bearer (SRB) and/or a data radio bearer (DRB), and is carried by at least one of the following: a radio resource control (RRC) message, a medium access control (MAC) control element (CE), or uplink control information (UCI).

In some embodiments, the network device receives request information for requesting the configuration information transmitted by the terminal equipment.

In some embodiments, the request information includes at least one of the following: model content information, model transmission configuration information, or model type information.

For example, the model content information includes at least one of the following: model structure information, neural network layer information, weight information, partial model content information, weight location information, partial model content location information, model storage related information, or content information carrying model data.

In some embodiments, the request information is transmitted through at least one of the following: a radio resource control (RRC) message, a medium access control (MAC) control element (CE), or uplink control information (UCI).

In some embodiments, the network device transmits assistance information to the terminal equipment; the assistance information includes an expected performance and/or expected maximum time of reception.

In some embodiments, the network device receives specified information transmitted by the terminal equipment, and the network device generates or reassembles the model according to the specified information.

In some embodiments, the specified information includes at least one of the following: model identity information, content description information, data statistics information, or model content information.

For example, the model content information includes weight initialization information, partial model content initialization information, and partial weight information.

For another example, the partial weight information includes: layer identity, inter layer location identity, intra layer location identity, and weight difference corresponding to the location; the partial model content information includes: content identity, content location identity, and weight difference corresponding to the location.

The above explanation is based on the example of a data transmission apparatus as the terminal equipment and a data reception apparatus as the network device. The present application is not limited to this, and the following explanation will be given by taking a data transmission apparatus as the network device and a data reception apparatus as the terminal equipment, and the same content mentioned above will be omitted.

In some embodiments, the terminal equipment receives configuration information transmitted by the network device, and the configuration information is used for configuring or indicating the terminal equipment to receive at least a part of a model stored in the network device; the terminal equipment receives the at least a part of the model transmitted by the network device according to the configuration information.

In some embodiments, the configuration information is carried by at least one of a radio resource control message, a medium access control control element, or downlink control information.

In some embodiments, at least part of the model is transmitted through a signaling radio bearer (SRB) and/or a data radio bearer (DRB).

In some embodiments, the at least a part of the model is carried by at least one of a radio resource control (RRC) message, a medium access control (MAC) control element (CE), or uplink control information (UCI).

In some embodiments, the terminal equipment transmits terminal capability information and/or model identification information to the network device, the terminal capability information and/or the model identification information being used by the network device to generate the configuration information.

In some embodiments, the terminal equipment receives a request for requesting terminal capability and/or model identification transmitted by the network device; the terminal equipment transmits the terminal capability information and/or the model identification information to the network device according to the request.

In some embodiments, the terminal capability information and/or the model identification information include information of capability for transmitting part of the content of the model.

In some embodiments, the configuration information includes model information and/or transmission information.

In some embodiments, the terminal equipment transmits request information for requesting the configuration information to the network device.

In some embodiments, the request information includes at least one of the following: model content information, model transmission configuration information, or model type information.

In some embodiments, the request information is transmitted through at least one of the following: a radio resource control (RRC) message, a medium access control (MAC) control element (CE), or uplink control information (UCI).

In some embodiments, the terminal equipment transmits assistance information to the network device; the assistance information includes an expected performance and/or expected maximum time of reception.

In some embodiments, the terminal equipment receives specified information transmitted by the network device, and the terminal equipment generates or reassembles the model according to the specified information.

In some embodiments, the specified information including at least one of the following: model identity information, content description information, data statistics information, or model content information.

In some embodiments, the terminal equipment receives indication information of retransmitting or suspending transmission or terminating transmission transmitted by the network device.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, interaction is performed between a network device and a terminal equipment, part of the model is transmitted as needed based on interaction information, thus it is possible to achieve air interface transmission of relatively large models, meet the requirements of AI/ML model transmission, and solve various potential problems caused by the transmission of AI/ML models between entities.

### Embodiments of Third Aspect

The embodiments of the present application provide a model transmission apparatus configured on a terminal equipment. Since the function of the model transmission apparatus to solve the problem is the same as the method described in the embodiments of the first aspect, the specific implementation thereof may be realized referring to the embodiments of the first aspect, and the same contents will not be repeated.

FIG. 7 is a schematic diagram of a model transmission apparatus in the embodiments of the present application. As shown in FIG. 7, a model transmission apparatus 700 includes:
a first receiving unit 701 configured to receive configuration information from a network device, the configuration information being used for configuring or indicating the terminal equipment to transmit at least a part of a model stored in the terminal equipment; and
a first transmitting unit 702 configured to transmit the at least a part of the model to the network device according to the configuration information.

It is worth noting that FIG. 7 above only schematically illustrates the embodiments of the present application, but the present application is not limited to this. For example, some other modules or components may be appropriately added or some modules or components thereof may be reduced. Those skilled in the art may make appropriate variations in accordance with the above contents, and which is not limited to the disclosure of FIG. 7 above.

In some embodiments, the configuration information includes at least model information and/or transmission information.

For example, the model information includes at least one of the following: model structure information, model type information, model layer information, model parameter information, model weight type, model weight accuracy information, or model transmission type.

For example, the transmission information may include transmission configuration information and/or transmission format information; the transmission configuration information includes at least one of the following: transmission period, maximum available resources for transmission, maximum time delay for transmission, or transmission silence window.

In some embodiments, the configuration information is carried by at least one of a radio resource control message, a medium access control control element, or downlink control information.

In some embodiments, the at least a part of the model is transmitted via a signaling radio bearer (SRB) and/or a data radio bearer (DRB), and is carried by at least one of the following: a radio resource control (RRC) message, a medium access control (MAC) control element (CE), or uplink control information (UCI).

In some embodiments, the first transmitting unit 702 further transmits terminal capability information and/or model identification information to the network device, the terminal capability information and/or the model identification information being used by the network device to generate the configuration information.

In some embodiments, the first transmitting unit 702 further transmits request information for requesting the model transmission information to the network device.

In some embodiments, the request information includes at least one of the following: model content information, model transmission configuration information, or model type information. For example, the model content information includes at least one of the following: model structure information, neural network layer information, weight information, partial model content information, weight location information, partial model content location information, model storage related information, or content information carrying model data.

In some embodiments, the request information is transmitted through at least one of the following: a radio resource control (RRC) message, a medium access control (MAC) control element (CE), or uplink control information (UCI).

In some embodiments, the first receiving unit 701 further receives assistance information from the network device; the assistance information includes an expected performance and/or expected maximum time of reception.

In some embodiments, the first transmitting unit 702 further transmits specified information for generating or reassembling the model to the network device.

In some embodiments, the specified information including at least one of the following: model identity information, content description information, data statistics information, or model content information.

For example, the model content information includes weight initialization information, partial model content initialization information, and partial weight information. The partial weight information includes: layer identity, inter layer location identity, intra layer location identity, and weight difference corresponding to the location; the partial model content information includes: content identity, content location identity, and weight difference corresponding to the location.

In addition, for the sake of simplicity, FIG. 7 only exemplarily shows the connection relationship or signal trend between the individual components or modules, but it should be clear to those skilled in the art that various related techniques such as bus connections may be employed. The above individual components or modules may be implemented by hardware facilities such as a processor, a memory, a transmitter, a receiver, etc., which is not limited in the present application.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, interaction is performed between a network device and a terminal equipment, part of the model is transmitted as needed based on interaction information, thus it is possible to achieve air interface transmission of relatively large models, meet the requirements of AI/ML model transmission, and solve various potential problems caused by the transmission of AI/ML models between entities.

### Embodiments of Fourth Aspect

The embodiments of the present application provide a model reception apparatus configured on a network device. Since the function of the model reception apparatus to solve the problem is the same as the method described in the embodiments of the second aspect, the specific implementation thereof may be realized referring to the embodiments of the first and second aspects, and the same contents will not be repeated.

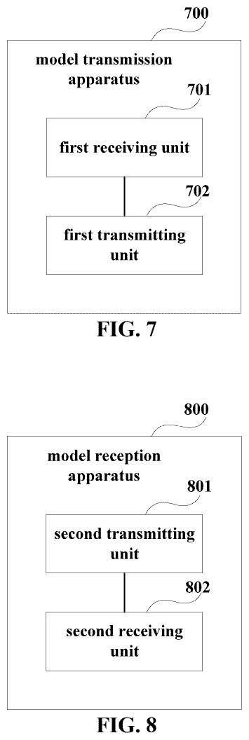

FIG. 8 is a schematic diagram of a model reception apparatus in the embodiments of the present application. As shown in FIG. 8, a model reception apparatus 800 includes:
a second transmitting unit 801 configured to transmit configuration information from a network device to a terminal equipment, the configuration information being used for configuring or indicating the terminal equipment to transmit at least a part of a model stored in the terminal equipment; and
a second receiving unit 802 configured to receive the at least a part of the model transmitted by the terminal equipment according to the configuration information.

It is worth noting that FIG. 8 above only schematically illustrates the embodiments of the present application, but the present application is not limited to this. For example, some other modules or components may be appropriately added or some modules or components thereof may be reduced. Those skilled in the art may make appropriate variations in accordance with the above contents, and which is not limited to the disclosure of FIG. 8 above.

In some embodiments, the configuration information includes at least model information and/or transmission information.

For example, the model information includes at least one of the following: model structure information, model type information, model layer information, model parameter information, model weight type, model weight accuracy information, or model transmission type.

For example, the transmission information may include transmission configuration information and/or transmission format information; the transmission configuration information includes at least one of the following: transmission period, maximum available resources for transmission, maximum time delay for transmission, or transmission silence window.

In some embodiments, the configuration information is transmitted through at least one of the following methods: capability transmission, model identification, or real-time specification. The configuration information is carried by at least one of a radio resource control message, a medium access control control element, or downlink control information.

In some embodiments, the at least a part of the model is transmitted via a signaling radio bearer (SRB) and/or a data radio bearer (DRB), and is carried by at least one of the following: a radio resource control (RRC) message, a medium access control (MAC) control element (CE), or uplink control information (UCI).

In some embodiments, the second receiving unit 802 further receives terminal capability information and/or model identification information from the terminal equipment, the terminal capability information and/or the model identification information being used by the network device to generate the configuration information.

In some embodiments, the second receiving unit 802 further receives request information for requesting the model transmission information transmitted by the terminal equipment.

In some embodiments, the request information includes at least one of the following: model content information, model transmission configuration information, or model type information.

For example, the model content information includes at least one of the following: model structure information, neural network layer information, weight information, partial model content information, weight location information, partial model content location information, model storage related information, or content information carrying model data.

In some embodiments, the request information is carried through at least one of the following: a radio resource control (RRC) message, a medium access control (MAC) control element (CE), or uplink control information (UCI).

In some embodiments, the second receiving unit 802 further receives specified information for generating or reassembling the model transmitted by the terminal equipment.

In some embodiments, the specified information includes at least one of the following: model identity information, content description information, data statistics information, or model content information. For example, the model content information includes weight initialization information, partial model content initialization information, or partial weight information. The partial weight information includes: layer indentity, inter layer location indentity, intra layer location indentity, and weight difference corresponding to the location; the partial model content information includes: content indentity, content location indentity, and weight difference corresponding to the location.

In addition, for the sake of simplicity, FIG. 8 only exemplarily shows the connection relationship or signal trend between the individual components or modules, but it should be clear to those skilled in the art that various related techniques such as bus connections may be employed. The above individual components or modules may be implemented by hardware facilities such as a processor, a memory, a transmitter, a receiver, etc., which is not limited in the present application.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, interaction is performed between a network device and a terminal equipment, part of the model is transmitted as needed based on interaction information, thus it is possible to achieve air interface transmission of relatively large models, meet the requirements of AI/ML model transmission, and solve various potential problems caused by the transmission of AI/ML models between entities.

### Embodiments of Fifth Aspect

The embodiments of the present application provide a communication system. FIG. 1 is a schematic diagram of the communication system of the embodiments of the present application. As shown in FIG. 1, the communication system 100 includes a network device 101, a terminal equipment 102 and a location server 103. For the sake of simplicity, FIG. 1 gives exemplary illustration by taking only one network device and one terminal equipment as an example, but the embodiments of the present application are not limited to this.

In some embodiments, the communication system includes:
a network device configured to transmit configuration information to a terminal equipment, the configuration information being used for configuring or indicating the terminal equipment to transmit at least a part of a model stored in the terminal equipment; and receive the at least a part of the model transmitted by the terminal equipment according to the configuration information; and
the terminal equipment configured to receive the configuration information, and transmit the at least a part of the model according to the configuration information.

The embodiments of the present application further provide an electronic device. The electronic device is, for example, a model transmission apparatus or a model reception apparatus described above.

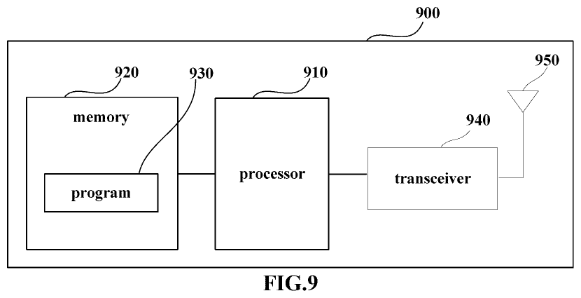

FIG. 9 is a schematic diagram of composition of the electronic device in the embodiments of the present application. As shown in FIG. 9, an electronic device 900 may include a processor 910 (such as a central processing unit (CPU)) and a memory 920; the memory 920 is coupled to the processor 910. The memory 920 may store various data and also may store the information processing program 930, and the program 930 is executed under the control of the processor 910.

For example, the processor 910 may be configured to execute the program to implement the model transmission method as described in the embodiments of the first aspect. For example, the processor 910 may be configured to perform the following controls of: receiving configuration information from a network device, the configuration information being used for configuring or indicating the terminal equipment to transmit at least a part of a model stored in the terminal equipment; and transmitting the at least a part of the model to the network device according to the configuration information.

For another example, the processor 910 may be configured to execute the program to implement the model reception method as described in the embodiments of the second aspect. For example, the processor 910 may be configured to perform the following controls of: transmitting configuration information to a terminal equipment, the configuration information being used for configuring or indicating the terminal equipment to transmit at least a part of a model stored in the terminal equipment; and receiving the at least a part of the model transmitted by the terminal equipment according to the configuration information.

In addition, as shown in FIG. 9, the electronic device 900 may further include: a transceiver 940 and an antenna 950, etc.; wherein the functions of the above components are similar to the related art, and will not be repeated here. It is worth noting that the electronic device 900 is not necessarily required to include all of the components shown in FIG. 9; in addition, the electronic device 900 may further include components not shown in FIG. 9, with reference to the related art.

The embodiments of the present application further provide a computer readable program which, when being executed in a model transmission apparatus, causes a computer to execute the model transmission method described in the embodiments of the first aspect in the model transmission apparatus.

The embodiments of the present application further provide a storage medium storing a computer readable program which causes the computer to execute the model transmission method described in the embodiments of the first aspect in the model transmission apparatus.

The embodiments of the present application further provide a computer readable program which, when being executed in a model reception apparatus, causes a computer to execute the model reception method described in the embodiments of the second aspect in the model reception apparatus.

The embodiments of the present application further provide a storage medium storing a computer readable program which causes the computer to execute the model reception method described in the embodiments of the second aspect in the model reception apparatus.

The above devices and methods of the present application may be implemented by hardware or by hardware combined with software. The present application relates to a computer readable program which, when being executed by a logic unit, enables the logic unit to implement the devices or components mentioned above, or enables the logic unit to implement the methods or steps described above. The logic unit is, for example, a field programmable logic unit, a microprocessor, a processor used in the computer, etc. The present application also relates to storage medium for storing the above programs, such as a hard disk, a magnetic disk, a compact disc, a DVD, a flash memory, etc.

The method/device described in conjunction with the embodiments of the present application may be directly embodied as hardware, a software module executed by the processor, or a combination of both. For example, one or more of the functional block diagrams and/or combination thereof shown in the drawing may correspond to both software modules and hardware modules of the computer program flow. These software modules may correspond to the steps shown in the drawings respectively. These hardware modules may be realized, for example, by solidifying these software modules using field programmable gate arrays (FPGA).

The software module may reside in an RAM memory, a flash memory, an ROM memory, an EPROM memory, an EEPROM memory, a register, a hard disk, a removable disk, a CD-ROM, or a storage medium in any other form known in the art. A storage medium may be coupled to a processor so that the processor may read information from the storage medium and write information to the storage medium; or the storage medium may be a constituent part of the processor. The processor and the storage medium may be located in the ASIC. The software module may be stored in the memory of the mobile terminal or in a memory card that may be inserted into the mobile terminal. For example, if a device (such as a mobile terminal) uses a large-capacity MEGA-SIM card or a large-capacity flash memory device, the software module may be stored in the MEGA-SIM card or the large-capacity flash memory device.

One or more of the functional blocks and/or combination thereof shown in the drawing may be implemented as a general-purpose processor, a digital signal processor (DSP), an application-specific integrated circuit (ASIC), a field programmable gate array (FPGA) or other programmable logic device, a discrete gate or a transistor logic device, a discrete hardware component, or any appropriate combination thereof, for performing the functions described in the present application. One or more of the functional blocks and/or combination thereof shown in the drawing may also be implemented as combination of computing devices, such as combination of DSP and a microprocessor, multiple microprocessors, one or more microprocessors combined with DSP communication, or any other such configuration.

The present application is described in combination with specific embodiments hereinabove, but a person skilled in the art should know clearly that the description is exemplary, but not limitation to the protection scope of the present application. A person skilled in the art may make various variations and modifications to the present application according to spirit and principle of the application, and these variations and modifications should also be within the scope of the present application.

With respect to the above-mentioned embodiments disclosed in the embodiments, the following supplements are further disclosed:
1. A model transmission method, including:
   a terminal equipment receiving configuration information from a network device, the configuration information being used for configuring or indicating the terminal equipment to transmit at least a part of a model stored in the terminal equipment;
   the terminal equipment transmitting the at least a part of the model to the network device according to the configuration information.
2. The method according to the supplement 1, wherein the configuration information is carried by at least one of the following: a radio resource control message, a medium access control control element, or downlink control information.
3. The method according to the supplement 1 or 2, wherein at least part of the model is transmitted through a signaling radio bearer (SRB) and/or a data radio bearer (DRB).
4. The method according to any one of the supplements 1 to 3, wherein the at least a part of the model is carried by at least one of a radio resource control (RRC) message, a medium access control (MAC) control element (CE), or uplink control information (UCI).
5. The method according to any one of the supplements 1 to 4, wherein the method further includes:
   the terminal equipment transmitting terminal capability information and/or model identification information to the network device, the terminal capability information and/or the model identification information being used by the network device to generate the configuration information.
6. The method according to the supplement 5, wherein the method further includes:
   the terminal equipment receiving a request for requesting terminal capability and/or model identification transmitted by the network device;
   the terminal equipment transmitting the terminal capability information and/or the model identification information to the network device according to the request.
7. The method according to the supplement 5 or 6, wherein the terminal capability information and/or the model identification information include information of capability for transmitting part of the content of the model.
8. The method according to any one of the supplements 1 to 7, wherein the configuration information includes model information and/or transmission information.
9. The method according to any one of the supplements 1 to 8, wherein the method further includes:
   the terminal equipment transmitting request information for requesting the model transmission information to the network device.
10. The method according to the supplement 9, wherein the request information includes at least one of the following: model content information, model transmission configuration information, or model type information.
11. The method according to the supplement 9 or 10, wherein the request information is transmitted through at least one of the following: a radio resource control (RRC) message, a medium access control (MAC) control element (CE), or uplink control information (UCI).
12. The method according to any one of the supplements 1 to 11, wherein the method further includes:
   the terminal equipment receiving assistance information from the network device; the assistance information including an expected performance and/or expected maximum time of reception.
13. The method according to any one of the supplements 1 to 12, wherein the method further includes:
   the network device transmitting specified information for generating or reassembling the model to the terminal equipment.
14. The method according to the supplement 13, wherein the specified information including at least one of the following: model identity information, content description information, data statistics information, or model content information.
15. The method according to any one of the supplements 1 to 14, wherein the method further includes:
   the terminal equipment further receiving indication information for retransmitting or suspending or terminating transmission transmitted by the network device.
16. A model reception method including:
   a network device transmitting configuration information to a terminal equipment, the configuration information being used for configuring or indicating the terminal equipment to transmit at least a part of a model stored in the terminal equipment; and the network device receiving the at least a part of the model transmitted by the terminal equipment according to the configuration information.
17. The method according to the supplement 16, wherein the configuration information is carried by at least one of the following: a radio resource control message, a medium access control control element, or downlink control information.
18. The method according to the supplement 16 or 17, wherein at least part of the model is transmitted through a signaling radio bearer (SRB) and/or a data radio bearer (DRB).
19. The method according to any one of the supplements 16 to 18, wherein the at least a part of the model is carried by at least one of a radio resource control (RRC) message, a medium access control (MAC) control element (CE), or uplink control information (UCI).
20. The method according to any one of the supplements 16 to 19, wherein the method further includes:
   the network device receiving terminal capability information and/or model identification information from the terminal equipment, the terminal capability information and/or the model identification information being used by the network device to generate the configuration information.
21. The method according to the supplement 20, wherein the method further includes:
   the network device transmitting a request for requesting terminal capability and/or model identification to the terminal equipment;
   the terminal equipment transmitting the terminal capability information and/or the model identification information to the network device according to the request.
22. The method according to the supplement 20 or 21, wherein the terminal capability information and/or the model identification information include information of capability for transmitting part of the content of the model.
23. The method according to any one of the supplements 16 to 22, wherein the configuration information includes model information and/or transmission information.
24. The method according to any one of the supplements 16 to 23, wherein the method further includes:
   the network device receiving request information for requesting the configuration information transmitted by the terminal equipment.
25. The method according to the supplement 24, wherein the request information includes at least one of the following: model content information, model transmission configuration information, or model type information.
26. The method according to the supplement 24 or 25, wherein the request information is transmitted through at least one of the following: a radio resource control (RRC) message, a medium access control (MAC) control element (CE), or uplink control information (UCI).
27. The method according to any one of the supplements 16 to 26, wherein the method further includes:
   the network device transmitting assistance information to the terminal equipment; the assistance information including an expected performance and/or expected maximum time of reception.
28. The method according to any one of the supplements 16 to 27, wherein the method further includes:
   the terminal equipment receiving specified information transmitted by the network device; and
   the network device generating or reassembling the model according to the specified information.
29. The method according to the supplement 28, wherein the specified information includes at least one of the following: model identity information, content description information, data statistics information, or model content information.
30. The method according to any one of the supplements 16 to 29, wherein the method further includes:
   the terminal equipment receiving indication information for retransmitting or suspending or terminating transmission transmitted by the network device.
31. A terminal equipment including a memory storing a computer program and a processor configured to execute the computer program to implement the model transmission method according to any one of the supplements 1 to 15.
32. A network device including a memory storing a computer program and a processor configured to execute the computer program to implement the model reception method according to any one of the supplements 16 to 30.
33. A model transmission method, including:
   a network device transmitting configuration information to a terminal equipment, the configuration information being used for configuring or indicating the terminal equipment to receive at least a part of a model stored in the network device; and
   the network device transmitting the at least a part of the model to the terminal equipment according to the configuration information.
34. The method according to the supplement 33, wherein the configuration information is carried by at least one of the following: a radio resource control message, a medium access control control element, or downlink control information.
35. The method according to the supplement 33 or 34, wherein at least part of the model is transmitted through a signaling radio bearer (SRB) and/or a data radio bearer (DRB).
36. The method according to any one of the supplements 33 to 35, wherein the at least a part of the model is carried by at least one of a radio resource control (RRC) message, a medium access control (MAC) control element (CE), or downlink control information (DCI).
37. The method according to any one of the supplements 33 to 36, wherein the method further includes:
   the network device receiving terminal capability information and/or model identification information transmitted by the terminal equipment, the terminal capability information and/or the model identification information being used by the network device to generate the configuration information.
38. The method according to the supplement 37, wherein the method further includes: the network device transmitting a request for requesting terminal capability and/or model identification to the terminal equipment; wherein the terminal equipment transmits the terminal capability information and/or the model identification information to the network device according to the request.
39. The method according to the supplement 37 or 38, wherein the terminal capability information and/or the model identification information include information of capability for transmitting part of the content of the model.
40. The method according to any one of the supplements 33 to 39, wherein the configuration information includes model information and/or transmission information.
41. The method according to any one of the supplements 33 to 40, wherein the method further includes:
   the network device receiving request information for requesting the configuration information transmitted by the terminal equipment.
42. The method according to the supplement 41, wherein the request information includes at least one of the following: model content information, model transmission configuration information, or model type information.
43. The method according to the supplement 41 or 42, wherein the request information is transmitted through at least one of the following: a radio resource control (RRC) message, a medium access control (MAC) control element (CE), or uplink control information (UCI).
44. The method according to any one of the supplements 33 to 43, wherein the method further includes:
   the network device receiving assistance information from the terminal equipment; the assistance information including an expected performance and/or expected maximum time of reception.
45. The method according to any one of the supplements 33 to 44, wherein the method further includes:
   the network device transmitting specified information for generating or reassembling the model to the terminal equipment.
46. The method according to the supplement 45, wherein the specified information includes at least one of the following: model identity information, content description information, data statistics information, or model content information.
47. The method according to any one of the supplements 33 to 46, wherein the method further includes:
   the network device transmitting indication information of retransmitting or suspending transmission or terminating transmission to the terminal equipment.
48. A model reception method including:
   a terminal equipment receiving configuration information transmitted by a network device, the configuration information being used for configuring or indicating the terminal equipment to receive at least a part of a model stored in the network device; and
   the terminal equipment receiving the at least a part of the model transmitted by the network device according to the configuration information.
49. The method according to the supplement 48, wherein the configuration information is carried by at least one of the following: a radio resource control message, a medium access control control element, or downlink control information.
50. The method according to the supplement 48 or 49, wherein at least part of the model is transmitted through a signaling radio bearer (SRB) and/or a data radio bearer (DRB).
51. The method according to any one of the supplements 48 to 50, wherein the at least a part of the model is carried by at least one of a radio resource control (RRC) message, a medium access control (MAC) control element (CE), or uplink control information (UCI).
52. The method according to any one of the supplements 48 to 51, wherein the method further includes:
   the terminal equipment transmitting terminal capability information and/or model identification information to the network device, the terminal capability information and/or the model identification information being used by the network device to generate the configuration information.
53. The method according to the supplement 52, wherein the method further includes: the terminal equipment receiving a request for requesting terminal capability and/or model identification transmitted by the network device;
   the terminal equipment transmitting the terminal capability information and/or the model identification information to the network device according to the request.
54. The method according to the supplement 52 or 53, wherein the terminal capability information and/or the model identification information include information of capability for transmitting part of the content of the model.
55. The method according to any one of the supplements 48 to 54, wherein the configuration information includes model information and/or transmission information.
56. The method according to any one of the supplements 48 to 55, wherein the method further includes:
   the terminal equipment transmitting request information for requesting the configuration information to the network device.
57. The method according to the supplement 56, wherein the request information includes at least one of the following: model content information, model transmission configuration information, or model type information.
58. The method according to the supplement 56 or 57, wherein the request information is transmitted through at least one of the following: a radio resource control (RRC) message, a medium access control (MAC) control element (CE), or uplink control information (UCI).
59. The method according to any one of the supplements 48 to 58, wherein the method further includes:
   the terminal equipment transmitting assistance information to the network device; the assistance information including an expected performance and/or expected maximum time of reception.
60. The method according to any one of the supplements 48 to 59, wherein the method further includes:
   the terminal equipment receiving specified information transmitted by the network device; and
   the terminal equipment generating or reassembling the model according to the specified information.
61. The method according to the supplement 60, wherein the specified information includes at least one of the following: model identity information, content description information, data statistics information, or model content information.
62. The method according to any one of the supplements 48 to 61, wherein the method further includes:
   the terminal equipment receiving indication information of retransmitting or suspending transmission or terminating transmission transmitted by the network device.
63. A network device including a memory storing a computer program and a processor configured to execute the computer program to implement the model transmission method according to any one of the supplements 1 to 15.
64. A terminal equipment including a memory storing a computer program and a processor configured to execute the computer program to implement the model reception method according to any one of the supplements 48 to 62.

What is claimed is:

1. A model transmission apparatus, configured in a terminal equipment, the apparatus comprising:
a receiver configured to receive configuration information from a network device, the configuration information being used for configuring or indicating the terminal equipment to transmit at least a part of a model stored in the terminal equipment; and
a transmitter configured to transmit the at least a part of the model to the network device according to the configuration information.

2. The apparatus according to claim 1, wherein the configuration information is carried by at least one of the following: a radio resource control message, a medium access control control element, or downlink control information.

3. The apparatus according to claim 1, wherein the at least a part of the model is transmitted via a signaling radio bearer and/or a data radio bearer, and is carried by at least one of the following:
a radio resource control message, a medium access control control element, or uplink control information.

4. The apparatus according to claim 1, wherein the transmitter further transmits terminal capability information and/or model identification information to the network device, the terminal capability information and/or the model identification information being used by the network device to generate the configuration information.

5. The apparatus according to claim 1, wherein the configuration information comprises model information and/or transmission information.

6. The apparatus according to claim 1, wherein the transmitter further transmits request information for requesting the configuration information to the network device, the request information being transmitted via at least one of the following: a radio resource control message, a medium access control control element, or uplink control information.

7. The apparatus according to claim 6, wherein the request information comprises at least one of the following: model content information, model transmission configuration information, or model type information.

8. The apparatus according to claim 1, wherein the receiver further receives assistance information from the network device, the assistance information comprising an expected performance and/or expected maximum time of reception of an application associated with the model.

9. The apparatus according to claim 1, wherein the transmitter further transmits specified information for generating or reassembling the model to the network device,
the specified information comprising at least one of the following: model identity information, content description information, data statistics information, or model content information.

10. The apparatus according to claim 1, wherein the receiver further receives indication information for retransmitting or suspending or terminating transmission transmitted by the network device.

11. A model reception apparatus, configured in a network device, the apparatus comprising:
a transmitter configured to transmit configuration information from a network device to a terminal equipment, the configuration information being used for configuring or indicating the terminal equipment to transmit at least a part of a model stored in the terminal equipment; and
a receiver configured to receive the at least a part of the model transmitted by the terminal equipment according to the configuration information.

12. The apparatus according to claim 11, wherein the configuration information is carried by at least one of the following: a radio resource control message, a medium access control control element, or downlink control information.

13. The apparatus according to claim 11, wherein the at least a part of the model is transmitted via a signaling radio bearer and/or a data radio bearer, and is carried by at least one of the following: a radio resource control message, a medium access control control element, or uplink control information.

14. The apparatus according to claim 11, wherein the receiver further receives terminal capability information and/or model identification information from the terminal equipment, the terminal capability information and/or the model identification information being used by the network device to generate the configuration information.

15. The apparatus according to claim 11, wherein the configuration information comprises model information and/or transmission information.

16. The apparatus according to claim 11, wherein the receiver further receives request information for requesting the configuration information transmitted by the terminal equipment, the request information being carried by at least one of the following: a radio resource control message, a medium access control control element, or uplink control information.

17. The apparatus according to claim 16, wherein the request information comprises at least one of the following: model content information, model transmission configuration information, or model type information.

18. The apparatus according to claim 11, wherein the transmitter further transmits assistance information to the terminal equipment, the assistance information comprising an expected performance and/or expected maximum time of reception of an application associated with the model.

19. The apparatus according to claim 11, wherein the receiver further receives specified information for generating or reassembling the model transmitted by the terminal equipment, the specified information comprising at least one of the following: model identity information, content description information, data statistics information, or model content information.

20. A communication system, comprising:
a network device configured to transmit configuration information to a terminal equipment, the configuration information being used for configuring or indicating the terminal equipment to transmit at least a part of a model stored in the terminal equipment; and receive the at least a part of the model transmitted by the terminal equipment according to the configuration information; and
the terminal equipment configured to receive the configuration information, and transmit the at least a part of the model according to the configuration information.
